(19) United States
(12) Patent Application Publication
(10) Pub. No.: US 2022/0036286 A1
(43) Pub. Date: Feb. 3, 2022

(54) Scheduled Log Instantiation

(71) Applicant: Highland Precision Agriculture, LLC, Mulberry, FL (US)

(72) Inventors: Kaylee Norris, Mulberry, FL (US); Marco Aguilar, Mulberry, FL (US)

(21) Appl. No.: 16/942,168

(22) Filed: Jul. 29, 2020

(51) Int. Cl. G06Q 10/06; G06F 16/25; G06F 16/23; G06F 9/451

(52) U.S. Cl. CPC G06Q 10/063118; G06F 9/451; G06F 16/2379; G06F 16/252

(57) ABSTRACT

Methods, systems, and apparatus, including computer programs encoded on a computer storage medium, for instantiating logs at scheduled times. Log requirements specify respective log items and a instantiation time for each log items. A service executes periodically, and determines an instantiation time window. For each log requirement having a instantiation time falling within the instantiation time window, a log item is instantiated. By instantiating log items only at times when the log items are to be completed, resources (e.g., memory) are conserved and the number of log items requiring attention are reduced.

### BACKGROUND

An agricultural enterprise includes multiple different sites, each of which is a unique physical location or area. For example, an agricultural enterprise may have several farm field locations, packinghouses, cold storage locations, etc. Typically the agricultural enterprise employees are assigned specific duties, and often for specific sites. For example, field workers may work primarily in a field location and report to a site supervisor. The site supervisor may be responsible for all teams assigned to the site or all teams assigned to multiple sites. Likewise, a team of employees may operation a packing facility, and report to a line supervisor. There may be several line supervisors at the packing facility, and each may manage a separate team of different employees.

To operate these various sites, certain actions must be performed periodically. For example, a field site may require a daily inspection of a water source, and a weekly inspection of a flood pond, and so on. A packinghouse may require daily inspections for sanitation, weekly inspections for machinery calibration, and so on. Additionally, state and federal regulations, as well as recording practices that are internal to the enterprise, may require logs detailing when actions were performed, and the results of such actions.

To ensure that the actions are performed, employees responsible for performing the actions may be provided reminders, either in paper form or electronically. In the case of the former, log sheets for each action at a site may be provided each day, while in the case of the latter, a list of actions to be performed for a site may be available through a workflow management system.

When the actions are completed, a log form is also completed. Each site may have multiple actions to be performed periodically (e.g., daily, weekly, monthly). Moreover, the agricultural enterprise may have multiple sites. Accordingly, a list of scheduled logs requiring completion may specify a large number of open logs, some of which are the same but for different times. The storage and management of so many open log items takes up unnecessary memory space, and is difficult for users to manage.

### SUMMARY

This specification describes technologies relating to instantiating logs at scheduled times. Log requirements specify respective log items and an instantiation time for each log item. A service executes periodically, and determines an instantiation time window. For each log requirement having an instantiation time falling within the instantiation time window, a log item is instantiated. By instantiating log items only at times when the log items are to be completed, resources (e.g., memory) are conserved and the number of open files requiring attention are reduced.

In general, one innovative aspect of the subject matter described in this specification can be embodied in methods that include the actions of storing, in a data store, a first association of a plurality of sites and a plurality of log requirements, wherein the first association associates, for each site, a set of log requirements for the site, wherein: each log requirement specifies an instantiation time that is a time a log item is instantiated, and each site specifies a particular physical location that is different from each other physical location for each other site; periodically executing, by a data processing apparatus, an instantiation service that instantiates log items, wherein for each execution the instantiation service: determines an instantiation time window measured from a start time and to an end time that occurs after the start time, processes the first association of the plurality of sites and the plurality of log requirements, and for each log requirement of the plurality of log requirements, determines whether the instantiation time for the log requirement specifies a time that occurs within the instantiation time window, for each log requirement determined to have an instantiation time that falls within the instantiation time window, instantiating the log item of the log requirement and storing the instantiated log items in a data store, and for each log requirement determined not to have an instantiation time that falls within the instantiation time window, not instantiating the log item of the log requirement. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. By instantiating log items only at times when the log items are to be completed, resources (e.g., memory) are conserved and the number of open files requiring attention are reduced.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is system diagram of a site management system that provides site specific notification.

FIG. 1B is a flow diagram of an example process for providing site specific notifications.

FIG. 2 is an illustration of a user interface for selecting user profiles.

FIG. 3 is an illustration of a user interface for providing user information for a user profile.

FIG. 4 is an illustration of a user interface for associating a user with one or more sites.

FIG. 5 is an illustration of a user interface for selecting permissions for a user.

FIG. 6 is an illustration of a user interface for providing setting notifications for a notified user.

FIG. 7 is a flow diagram of an example process for associating notifications for a site with a notified user for the site.

FIG. 8 is a flow diagram of an example process for identify log requirements that cannot be completed.

FIG. 9 is a flow diagram of an example process for instantiation of log items according to an instantiation service.

FIG. 10 is an illustration of a user interface for selecting a day for which a log instantiation is to occur.

FIG. 11 is an illustration of a user interface for a scheduler pane resulting from a selection of the user interface of FIG. 10.

FIG. 12 is an illustration of the user interface of FIG. 11 with an expansion for inputting recurrence data resulting from a selection of the repeat selector of FIG. 11.

FIG. 13 is an illustration of a user interface for showing instantiated log items prior to the executing of the scheduling service after the log requirement of FIG. 12 is saved.

FIG. 14 is an illustration of a user interface for showing instantiated log items after the executing of the scheduling service after the log requirement of FIG. 12 is saved.

Like reference numbers and designations in the various drawings indicate like elements.

### DETAILED DESCRIPTION

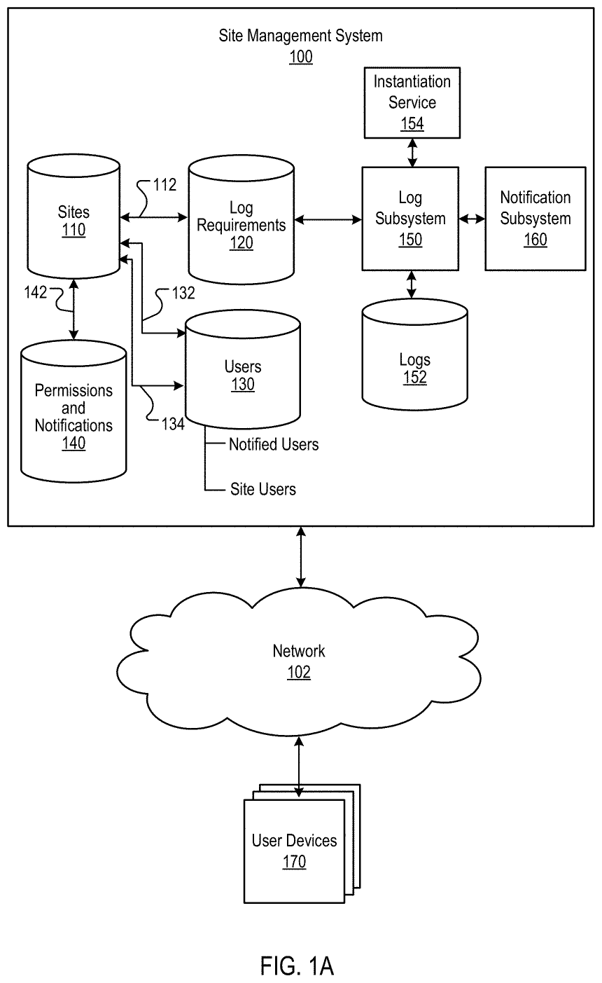

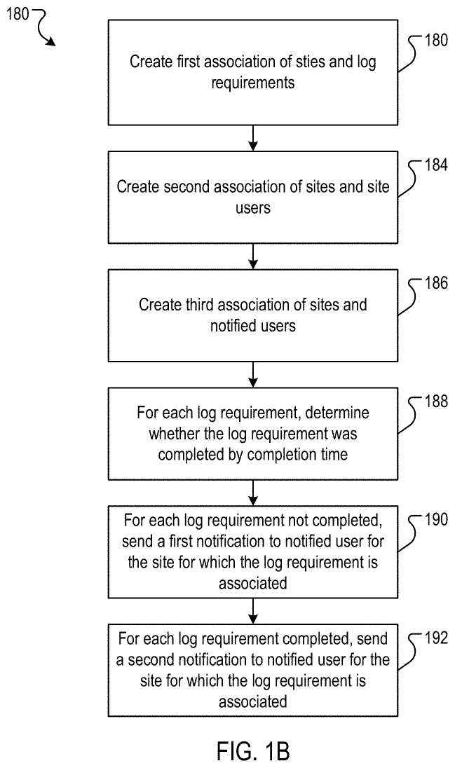

FIG. 1A is system diagram of a site management system 100 that provides specific notifications. The example architecture described in this specification is illustrative, and other architectures and functional distributions can also be used. The system 100 may be implemented in a data processing apparatus that includes one or more computer devices and that is operable to communicate over a network 102. The network 102 may be a local area network, a wide area network, or the Internet. The network 102 may also include or be in commutation with other networks, either directly or through gateways.

The system 100 includes sites data 110, log requirements data 120, user data 130, and permissions and notifications data 140. These data sets may be part of a single data set, such as a single database, or separate data sets with relational associations, or may be part of any other data structure that facilitates the relations and associations described below.

Operation of the system 100 is described with reference to FIG. 1B, which is a flow diagram of an example process 180 for providing site specific notifications. The process 180 is performed by computer devices that are used to realize the system of FIG. 1A.

The process 180 creates a first association 112 of sites and log requirements (182). In particular, the first association associates, for each site, a set of log requirements for the site. Each log requirement specifies a particular log item to be completed by a completion time, and each site specifies a particular physical location that is different from each other physical location for each other site. For example, a first farm location, e.g., Farm A, may have a first set of log requirements to be completed daily, and a second farm location, e.g., Farm B, may have a second set of log requirements to be completed daily. The sets of log requirements for each farm site may be the same, or may be different, with no overlap or partial overlap.

The log item specified by each log requirement is an item that must be completed by a user. As used in this specification, a log item is an addressable electronic resource, such as file, a set of items to be populated in a databased, or any other set of associated data, either as a single file or linked across files, for which memory storage resources are allocated upon instantiation of the log item. The log item may need to be completed periodically by a completion time, e.g., by the first day of each month, or daily, etc. The log item may specify an inspection to be performed, or the re-supplying of feed, or any other action required to be performed for a site.

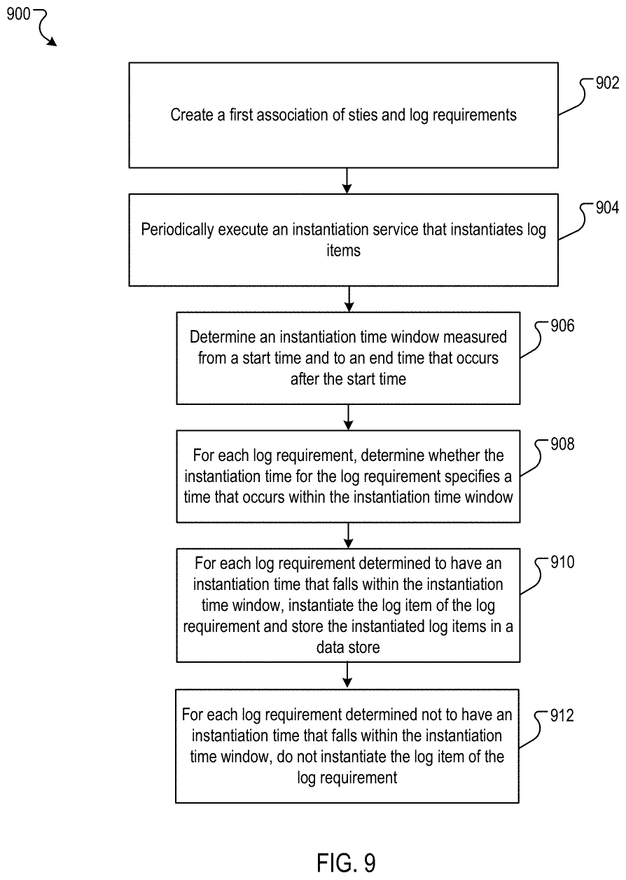

Each log requirement also specifies an instantiation time that is a time a log item is instantiated by an instantiation service 154. When a log item is instantiated, resources are allocated for the log item, and the log item is an item that can be displayed in a user interface. The creation and instantiation of log items is described in more detail with reference to FIGS. 9-14 below.

The process 180 creates a second association 132 of sites and sites users (184). In particular, a set of users that are specified as being responsible for the site are associated with the site as site users for the site. Again, the first farm location, e.g., Farm A, may have a first set of site users, and the second farm location, e.g., Farm B, may have a second set of site users. The sets of site users for each site may be the same, or the sets may be different, with no overlap or partial overlap.

Additionally, each site user is associated with at least one log requirement for the site. Users that are associated with a log requirement for a site are responsible for ensuring that the log item specified by the log requirement is completed by the completion time. The log items are usually completed electronically by use of user devices 170.

The process 180 creates a third association 134 of sites and notified users (186). In particular, for each site, there is at least one notified user that receives notifications for particular log items associated with the site. A notified user maybe a same user as a site user, or can be a different user. For example, assume that Farm A has 10 site users. Each of the 10 site users may be notified users. Alternatively, another user that is a supervisor of the 10 users may be the notified user for the Farm A site.

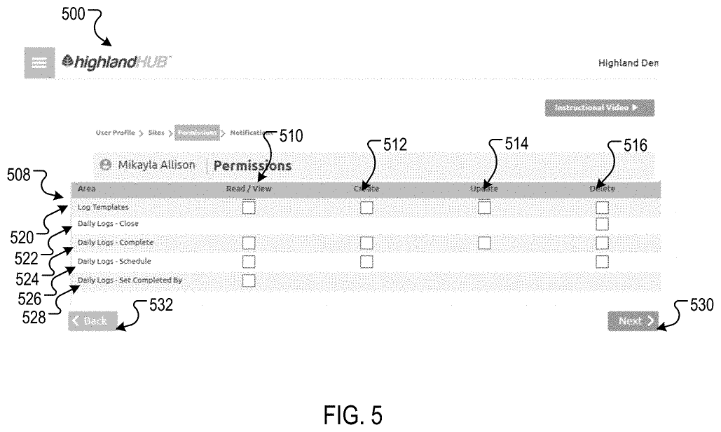

Site users for a site are assigned permission for the log items with which they are associated. User permissions are described in more detail with reference to FIG. 5 below. User permissions include a read permission and a write permission. The read permission enables a site user to read a log item of a log requirement with which the site user is associated, while the write permission enables a site user to write a log item of a log requirement with which the site user is associated. Other permissions can also be used.

Instantiated log items are stored in the logs data 152. As log items are completed, the log items are updated and stored in log data 152. A log subsystem 150 processes the logs 152 and the log requirements to determine which logs items are completed and which are not completed. For example, for each log requirement, the process 180 determines whether the log requirement is completed by the completion time of the log requirement (188). The determination may be done by the log subsystem 150 when a log item is completed before a completion time of the log item, or may be done at the completion time of the log item. In the case of the latter, the determination may occur well after the actual completion time. This latter implementation can be do “batch” processing of completion determination so that notifications can be sent a specific completions times, e.g., the end of a workday, or at the middle of the workday. The former implementation allows for resource balancing, which may be a factor for very large agricultural enterprises, as a large batch process at certain times of the day may stress computer resources. In some implementations, the step 188 is limited to process log requirements for which lot items have been instantiated as described with reference to FIGS. 9-14 below.

The process 180, for each log requirement determined not to be completed by the completion time for the log requirement, sends a first notification to notified user for the site for which the log requirement is associated (192). The first notification specifies the log item was not completed by the completion time. For example, the notification subsystem 160 may generate a first notification specifying the log requirement was not completed by the completion time, and then determine, based on the first association 112, the second association 132, and the third association 134, the notified user for the site for which the log requirement is associated. The log subsystem 160 then sends, to the notified user, the first notification. The first notification may be in the form of an e-mail, a text message with a link to a supervisory report, or any other appropriate mechanism to notify the notified user. A log item may be determined to not be completed when it has not been filled out, or has been completed incorrectly, such as partially completed and missing certain data when the log item is submitted by a user as completed.

The process 180, for each log requirement determined to be completed by the completion time for the log requirement, sends a second notification to notified user for the site for which the log requirement is associated (192). The second notification specifies the log item was completed by the completion time. For example, the notification subsystem 160 may generate a second notification specifying the log requirement was completed by the completion time, and then determine, based on the first association 112, the second association 132, and the third association 134, the notified user for the site for which the log requirement is associated. The log subsystem 160 then sends, to the notified user, the second notification. As with the first notification, the second notification may be in the form of an e-mail, a text message with a link to a supervisory report, or any other appropriate mechanism to notify the notified user.

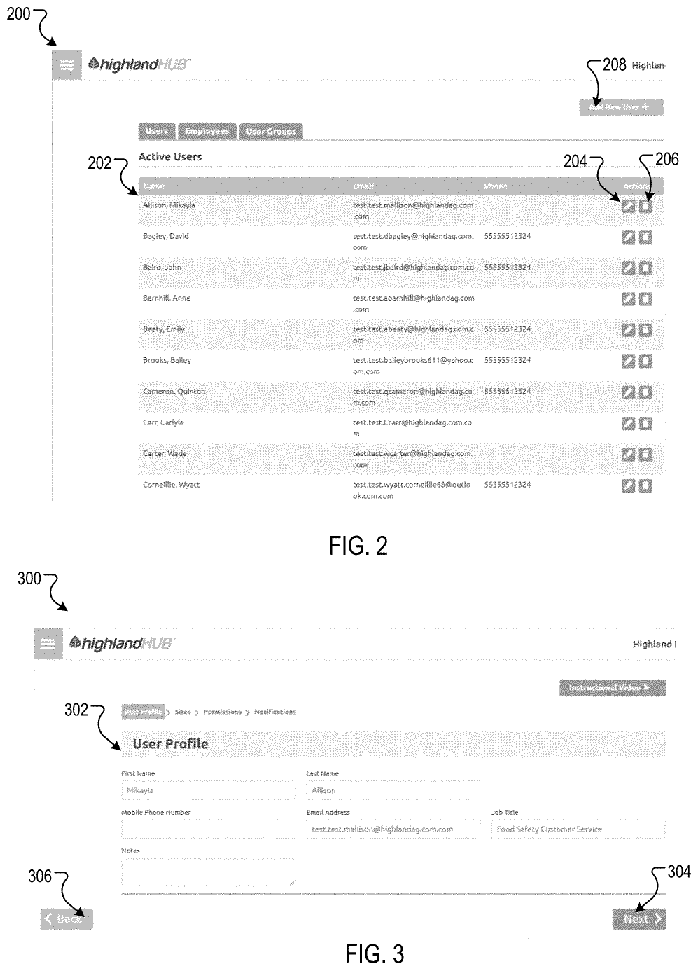

The creation and maintaining of the associations described above is done through the use of various user interfaces, which are describe with reference to FIGS. 2-6. Each user interface may be provided for display on a user device. The user interface may be browser based or may be rendered by a standalone application.

FIG. 2 is an illustration of a user interface 200 for selecting user profiles. The user interface 200 includes a column 202 of existing user profiles. A particular profile may be selected for editing by use of an edit button 204, or deleted by use of a deletion button 206. A new user profile may be created by use of an add new user button 208.

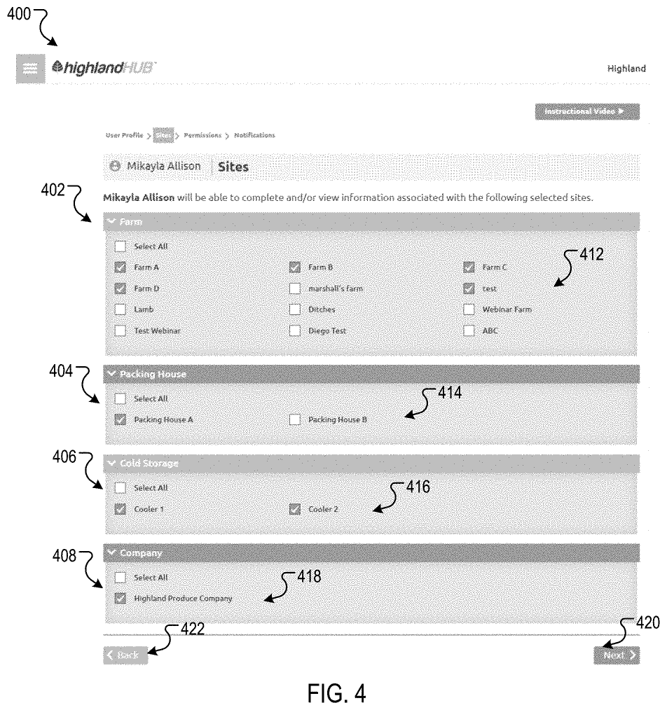

FIG. 3 is an illustration of a user interface 300 for providing user information for a user profile. The user interface 300 includes user data fields 302 that can be used to populate user data for a particular user, such as name, contact information, job title, etc. The name and contact information can be tied to an employee database to determine the user's supervisor, if any, and any employees the user supervises, if any. Selecting the next button 304 transitions to the user interface 400 of FIG. 4, and selecting the back button 306 transitions to the user interface 200 of FIG. 2.

FIG. 4 is an illustration of a user interface 400 for associating a user with one or more sites. The user interface 400 includes a set of site categories 402, 404, 406 and 408 that each includes a set of respective sites 412, 414, 416 and 418. A user may be associated with a particular site by selecting a check box selector that precedes each listed site. As shown in FIG. 4, the user is associated with nine selected sites. Selecting the next button 420 transitions to the user interface 500 of FIG. 5, and selecting the back button 422 transitions to the user interface 300 of FIG. 3. In some implementations, a user associated with a site is automatically associated with each log requirement for the site. In other implementations, the log requirements for a site may be individually selected for association with a user that is associated with the site.

FIG. 5 is an illustration of a user interface 500 for selecting permissions for a user. The user interface 500 includes a set of log requirements 508 and user permissions 510, 512, 514, and 516 for the log requirements 508. Some log requirements may only have a proper subset of the user permissions available for the site user, as the log item specified by the log requirement may not require certain actions or certain input that other log requirements may require.

The example log requirements include log templates 520, closed daily logs 422, completed daily logs 524, scheduled daily logs 526, and set completed by daily logs 528. Other or fewer log items can also be included. As described below, the actions association with permissions for each log requirement may differ.

The log template 520 allows a user to create logs using a log template tool. The read/view permission 510 is a read permission that allows the user to view published versions of all logs. The create permission 512 is a write permission that allows the user to create a log using a log template builder. The update permission 514 is a write permission that allows a user to edit an existing log used in the system. The delete permission 516 allows a user to delete a log out of the system.

The closed daily log 522 allows a user to enter a reason why a daily log was not completed and mark the log as “closed.” The only permission available is the delete permission 516, the selection of which allows the user to enter why the log was not completed.

The completed daily logs 524 relates to completed logs. The read/view permission 510 gives the user the ability to review completed logs. The create permission 512 give the user the ability to create and complete logs in the system. The update permission 514 allows a user to edit a completed log. The delete permission 516 allows a user to delete a log that has been marked as approved or completed.

The scheduled daily logs 526 relates to scheduling log items. The read/view permission 510 allows a user to view scheduled daily logs. The create permission 512 allows a user to schedule logs for a site, and the delete permission 516 allows a user to delete a log schedule.

The completed by daily logs 528 relates to who completed a log. The read/view 510 permission allows a user to specify which user completed a log, or change which user completed the log.

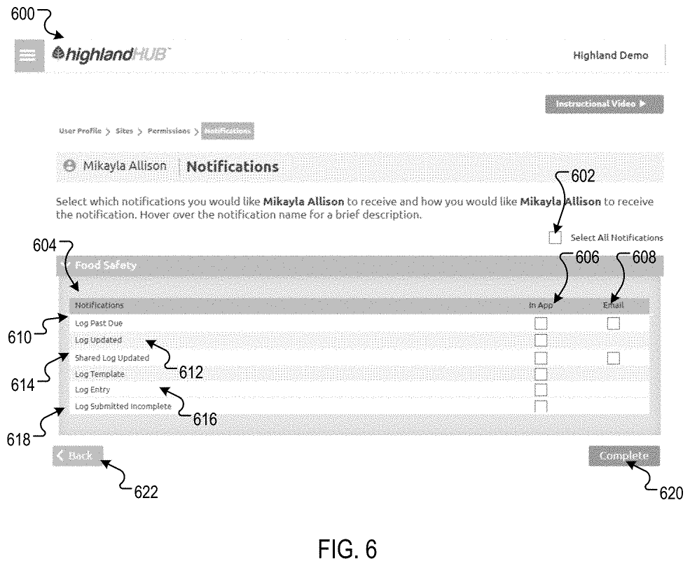

The selection of permissions are stored in the permissions and notifications data 140. Selecting the next button 530 transitions to the user interface 600 of FIG. 6, and selecting the back button 532 transitions to the user interface 400 of FIG. 4.

The user interface 500 of FIG. 5 can be used to give permissions for a user for all log items for a site or sites with which the user is associated. In other implementations, a user associated with a site can be association with only a proper subset of the logs for the site. For example, based on the second association 132 of the sites and the site users, the system 100 can determine, for each site user, each site with which the site user is associated. Then, for each site with which the site user is determined to be associated, the system 100 determines set of log requirements for the site. For example, assume a user is associated with the sites Farm A and Farm B. For each site, the log requirements for that site will be displayed according to the site with which they are associated.

The log requirements for each site may then be selected individually for the user, and the notifications for each log equipment so selected may then be set. This allows for a tailored list of log requirements for each site to be assigned to each user. For example, assume the sites Farm A and Farm B each have a dozen separate log requirements, and that a particular site user associated with both sites is only responsible for a pesticide log requirement for each site. The dozen log requirements for each site will be displayed, and only the pesticide log requirement will be selected for each site. Accordingly, the user will only have access to and permissions for the pesticide log item for each of site Farm A and Farm B.

FIG. 6 is an illustration of a user interface 600 for providing setting notifications for a notified user. The user interface 600 includes a selection 602 that results in a selection of all listed notifications 604. Alternatively, notifications can be selected individually. Notifications can be delivered within an application by selecting In App selection 608, or by e-mail by selecting the Email selection 610.

Example notifications include log past due 610, log updated 612, shared log updated 614, log entry 616, and log submitted incomplete 618. The log past due 610 notification causes the system to generate a notification when a log item is not completed by a completion time. The log update 612 notification cause the system to generate a notification when a completed log item is updated. The shared log 614 notification is a notification that is generated when a log shared with the notified user is updated. The log entry 616 notification causes the system to generate a notification when a new log item is generated for the site with which the notified user is responsible. The log submitted incomplete 618 notification causes the system to generate a notification when a log is submitted but is incomplete.

The notifications listed in FIG. 6 are illustrative, and addition notification types can also be used. Selecting complete button 620 saves the data generated from use of the user interfaces of FIGS. 2-6, and selecting the back button 622 transitions to the user interface 500 of FIG. 5.

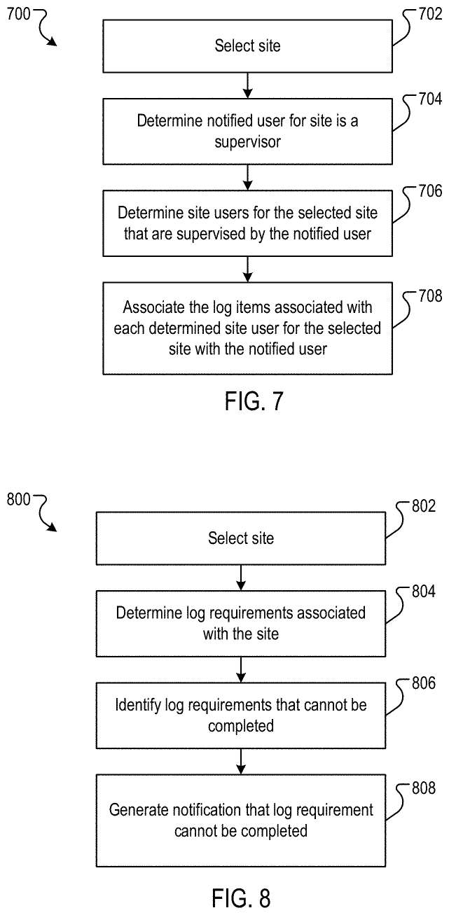

FIG. 7 is a flow diagram of an example process 700 for associating notifications for a site with a notified user for the site. The process 700 is used when an administer wants a supervisor to receive notifications for log items associated with site users that are supervised by the notified user.

The process 700 receives a site selection (702). The site selection specifies a particular site.

The process 700 determines the notified user for the site is a supervisor (704). In response, the process 700 then determines site users for the selected site that are supervised by the notified user (706).

Then, for each site user associated with the site and supervised by the notified user, the process 700 associates the log items associated with each determined site user for the selected site with the notified user (708). As a result, the notified user will receive notifications for all log items of site users supervised by the notified user. This process enables notified users to receive only notifies for log items associated with users they supervise.

In other implementations, an association to provide notifications for log requirements for a specific site are based on the notified user being responsible for the site. Thus, all notifications for the site will be provided to the notified user. This enables notifications to be provided to the notified user without requiring the direct reports to the notified user to be specified. In other words, the notifications are provided based on the notified user's site responsibility, and not based on a hierarchal employee/supervisor arrangement. This ensures that the notified user will be provided notifications despite employee attrition or employee changes, thus simplifying data management.

In still other implementations, an association to provide notifications for log requirements for a specific site are based on the notified user being responsible for the site, and based on the notified user being specifically associated with the specific log requirements. This enables notifications for a proper subset of log requirements for a site to be provided to the notified user without requiring the direct reports to the notified user to be specified. In other words, the notifications are provided based on the notified user's site responsibility and the proper subset of log requirements for which the notified user is responsible, and not based on a hierarchal employee/supervisor arrangement. Again, this ensures that the notified user will be provided notifications despite employee attrition or employee changes, thus simplifying data management. Moreover, the notified user is not provided with notification for which the notified user is not responsible.

FIG. 8 is a flow diagram of an example process 800 for identify log requirements that cannot be completed. The process 800 is used to ensure that each log requirement has at least one site user associated with it.

The process 800 receives a site selection (802). Then, for the selected site, the process 800 determines, based on the first association, the log requirements associated with the site (804).

The process 800 then identifies log requirements that cannot be completed (806). For example, for each log requirement associated with the site, the process 800 determines whether at least one site user, based on the second association, is associated with the log requirement and a write user permission. For each log requirement associated with the site and determined to not be associated with at least one site user and a write user permission, the log requirement is determined to be unable to be completed.

The process 800 then generates a notification indicating the log requirement cannot be completed (808). For example, the notification may indicate the log requirement does not have an associated site user that can write the log item specified by the log requirement.

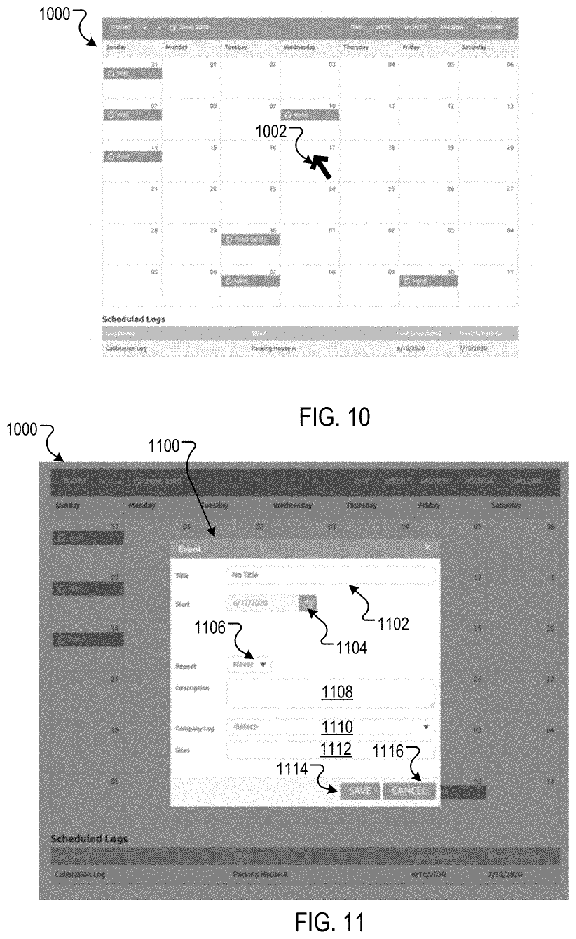

Operation of the system 100 for instantiating log items is described with reference to FIGS. 9-14. FIG. 9, in particular, is a flow diagram of an example process 900 for instantiation of log items according to the instantiation service 154. The process 900 is performed by computer devices that are used to realize the system of FIG. 1A, and is also described with reference to FIGS. 10-14, as appropriates.

The process 900 creates a first association of sties and log requirements (902). This is similar to process step 182 described above, where the first association is of a set of sites and log requirements, wherein the first association associates, for each site, a set of log requirements for the sites. However, in the process step 902, each log requirement specifies an instantiation time that is a time a log item is instantiated.

One example workflow for creating a first association with the instantiation time is described with reference to FIGS. 10-12. In particular, FIG. 10 is an illustration of a user interface 1000 for selecting a day for which a log instantiation is to occur. The example interface in FIG. 10 is calendar, but other types of interfaces can also be used, such as a site based interface or user based interface, for example. As shown in FIG. 10, a cursor 1002 is positioned over a particular day. Selection of the particular day causes a scheduler pane 1100 to be displayed over the user interface 1000, as illustrated in FIG. 11.

The scheduler pane 1100 enables a user set up a log requirement for which a log item is to be instantiated. The user may enter a title of the log requirement in the title field 1102, and a start date in the date selector 1104. The start date is the first date the log item is to be instantiated. If the log requirement is to be recurring, the user may select a recurring schedule by use of the repeat selector 1106. A recurrence may be multiple times per day, or daily, weekly, or monthly, etc.

The user may enter a description of the log requirement in the description field 1108, and select the particular log requirement by use of the log selector 1110. Finally, the user may associate the log requirement with a particular site by use of the site field 1112.

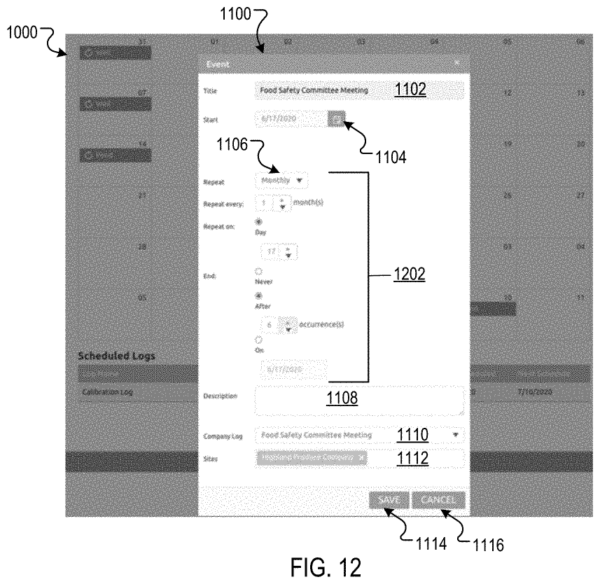

Assume that the user is generating a log item for a “Food Safety Committee Meeting” log requirement, which is a monthly meeting that is to occur beginning on the 17^{th} day of the selected month. The user enters the title “Food Safety Committee Meeting” in the title field 1102, confirms the start date of Jun. 17, 2020 in the date selector 1104, and then selects “monthly” from the repeat selector 1106. In response, and expansion 1202 for inputting recurrence data is generated in the scheduler pane 1110, as shown in FIG. 12. Scheduling information may then be input into the fields generated by the expansion 1202. The scheduling information may specify the repeat frequency, the date of the repeat, and an end date, if any. The data may then be persisted to the log requirements 120 by pressing the save button 1114, or may be discarded by pressing the cancel button 1116.

The start date is used as the instantiation time for the log requirement, and each repeated start date (e.g., each monthly date resulting from the scheduling data of FIG. 12) is also used an instantiation time. While the instantiation time shown is a day, additional granularity can be specified, e.g., a particular time of day, such as 8:00 AM. Thus, a recurring log requirement may have multiple instantiation times, where each instantiation time is a scheduled recurrence date.

As shown in FIG. 12, and as will be described in more detail below, a log requirement specifying the instantiation of a Food Safety Committee Meeting Log item will be generated monthly, and on the date the meeting is scheduled (or any time the instantiation service 154 executes and has an instantiation time window that includes the instantiation time of the log item).

The process 900 periodically executes an instantiation service that instantiates log items (904). During each execution of the instanton service 154, the process steps 906-912 are performed. First, the process 900 determines an instantiation time window measured from a start time and to an end time that occurs after the start time (906). For example, the start time may be the time that the instantiation service 154 begins running, or, alternatively, may be a time in the future. In the case of the latter, for example when the instantiation service 154 is run daily to generate a next day's logs, the instantiation service may run at 6:00 PM, and the start time may be midnight. The end time is a time measured after the start time. Continuing with the example, the end time may be 24 hours after the start time. Thus, the instantiation time window is a 24 hour period measured from the start time of midnight. Typically the instantiation process 154 is run so that the instantiation time windows are shifted so that a start time for a next instantiation time window is the same as the end time of a most recent execution of the instantiation service.

The process 900, for each log requirement, determines whether the instantiation time for the log requirement specifies a time that occurs within the instantiation time window (908). For example, assume that the instantiation service 154 runs on Jun. 16, 2020 at 6:00 PM with the start and end times described above. The log requirement generated as described above will have an instantiation time occurring within the instantiation time window (Jun. 17, 2020). Other log requirements may not have an instantiation time occurring within the instantiation time window (e.g., log requirement that occur on other days after Jun. 17, 2020, or before Jun. 17, 2020.

The process 900, for each log requirement determined to have an instantiation time that falls within the instantiation time window, instantiates the log item of the log requirement and store the instantiated log items in a data store (910). Conversely, for each log requirement determined not to have an instantiation time that falls within the instantiation time window, the process 900 does not instantiate the log item of the log requirement (912). Accordingly, for the log requirement generated as described above, which had an instantiation time occurring within the instantiation time window (Jun. 17, 2020), the process 900 generates a log item, and memory storage resources are allocated upon instantiation of the log item. For other log requirements that do not have an instantiation time occurring within the instantiation time window (e.g., log requirement that occur on other days after Jun. 17, 2020, or before Jun. 17, 2020, the process does not generate the corresponding log items.

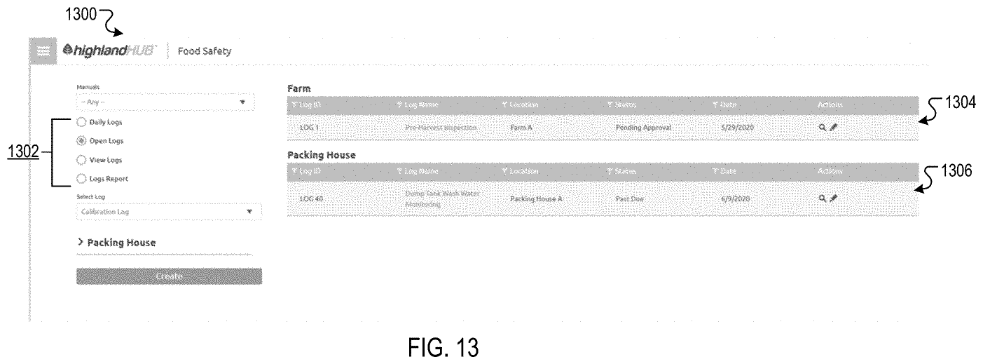

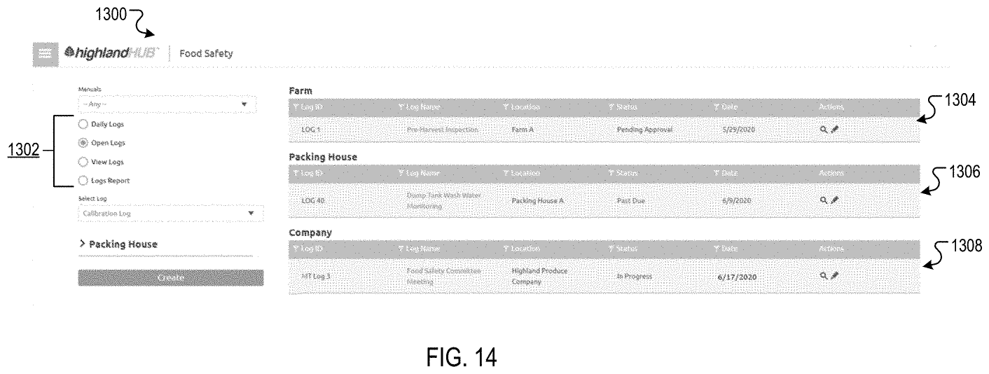

FIGS. 13 and 14 illustrate a user interface 1300 that displays instantiated log items before and after an execution of the instantiation service 154. The user interface 1300 is generated in response to display log items for a site or sites. The log subsystem 150 accesses the data store 152 to determine the instantiated log items for the site or sites, and generates and provides display data that causes the user device to display, in the user interface, the instantiated log items for the site or sites.

The user interface 1300 includes filter options 1302 for displaying log items. As shown in FIGS. 13 and 14, the filter options 1302 are selected to only display open log items (i.e., instantiated log items that have not been completed). FIG. 13 is the user interface 1300 on the date of Jun. 16, 2020, and before the instantiation service 154 has been executed. As shown, there are two instantiated log items 1304 and 1306 shown, the first 1304 associated with a farm site, and the second 1306 associated with a packing house site.

FIG. 14 is the user interface 1300 after the instantiation service 154 has been executed, i.e., on Jun. 16, 2020 after 6:00 PM or on Jun. 17, 2020 before 6:00 PM). As shown, there are now three instantiated log items 1304, 1306, and 1308. The new log item 1308 is the log item instantiated from the log requirement created as described above.

The user interface 1300 of FIGS. 13 and 14 display the log items for one or more sites. In other implementations, the user interface can be a calendar, where each day corresponds to an instantiation time window. This results in successive time windows in the form of past, current and future time windows, (days) being displayed. Accordingly, instantiated log items that are displayed will not include log items that have not yet been instantiated.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
storing, in a data store, a first association of a plurality of sites and a plurality of log requirements, wherein the first association associates, for each site, a set of log requirements for the site, wherein:
each log requirement specifies an instantiation time that is a time a log item is instantiated; and
each site specifies a particular physical location that is different from each other physical location for each other site;
periodically executing, by a data processing apparatus, an instantiation service that instantiates log items, wherein for each execution the instantiation service:
determines an instantiation time window measured from a start time and to an end time that occurs after the start time;
processes the first association of the plurality of sites and the plurality of log requirements, and for each log requirement of the plurality of log requirements, determines whether the instantiation time for the log requirement specifies a time that occurs within the instantiation time window;
for each log requirement determined to have an instantiation time that falls within the instantiation time window, instantiating the log item of the log requirement and storing the instantiated log items in a data store; and
for each log requirement determined not to have an instantiation time that falls within the instantiation time window, not instantiating the log item of the log requirement.

2. The method of claim 1, wherein:
each log requirement specifies a completion time for the log requirement; and
further comprising:
for each log requirement for which a log item has been instantiated, determining, by the data processing apparatus, whether the log requirement is completed by the completion time for the log requirement;
for each log requirement for which the log item has been instantiated and determined not to be completed by the completion time for the log requirement, generating a first notification specifying the log requirement was not completed by the completion time and sending the first notification to a notified user associated with the log requirement; and
for each log requirement for which the log item has been instantiated and determined to be completed by the completion time for the log requirement, generating a second notification specifying the log requirement was completed and sending the sending the second notification to a notified user associated with the log requirement.

3. The method of claim 2, wherein determining whether the log requirement is completed by the completion time for the log requirement comprises determining whether the log item has be completed by a site user associated with log requirement.

4. The method of claim 1, further comprising:
receiving, from a user device, a request for a user interface that displays log items for a site;
accessing the data store to determine the instantiated log items for the site; and
generating and providing to the user interface display data that causes the user device to display, in the user interface, the instantiated log items for the site.

5. The method of claim 1, further comprising:
receiving, from a user device, a request for a user interface that displays log items for a site according to a plurality of successive time windows, wherein the successive time windows include time windows that occur prior to a current time window, a current time window, and future time windows that occur after the current time window;
accessing the data store to determine the instantiated log items for the site; and
generating and providing to the user interface display data that causes the user device to display, in the user interface, the instantiated log items for the site.

6. The method of claim 5, wherein accessing the data store to determine the instantiated log items for the site comprises:
determining all instantiated log items for the site for the current time window and prior time windows; and
generating and providing to the user interface display data that causes the user device to display, in the user interface, the instantiated log items for the site for each of the current time window and the prior time windows.

7. The method of claim 1, wherein the instantiation time window is a daily window of 24 hours, and periodically executing the instantiation service that instantiates log items comprises executing the instantiation service daily.

8. A system, comprising:
one or more computers;
a non-transitory computer readable medium in data communication with the one or more computers and storing instructions executable by the one or more computers and that upon execution cause the one or more computers to perform operations comprising:
storing, in a data store, a first association of a plurality of sites and a plurality of log requirements, wherein the first association associates, for each site, a set of log requirements for the site, wherein:
each log requirement specifies an instantiation time that is a time a log item is instantiated; and
each site specifies a particular physical location that is different from each other physical location for each other site;
periodically executing an instantiation service that instantiates log items, wherein for each execution the instantiation service:
determines an instantiation time window measured from a start time and to an end time that occurs after the start time;
processes the first association of the plurality of sites and the plurality of log requirements, and for each log requirement of the plurality of log requirements, determines whether the instantiation time for the log requirement specifies a time that occurs within the instantiation time window;
for each log requirement determined to have an instantiation time that falls within the instantiation time window, instantiating the log item of the log requirement and storing the instantiated log items in a data store; and
for each log requirement determined not to have an instantiation time that falls within the instantiation time window, not instantiating the log item of the log requirement.

9. The system of claim 8, wherein:
each log requirement specifies a completion time for the log requirement; and
the operations further comprising:
for each log requirement for which a log item has been instantiated, determining, by the data processing apparatus, whether the log requirement is completed by the completion time for the log requirement;
for each log requirement for which the log item has been instantiated and determined not to be completed by the completion time for the log requirement, generating a first notification specifying the log requirement was not completed by the completion time and sending the first notification to a notified user associated with the log requirement; and
for each log requirement for which the log item has been instantiated and determined to be completed by the completion time for the log requirement, generating a second notification specifying the log requirement was completed and sending the sending the second notification to a notified user associated with the log requirement.

10. The system of claim 9, wherein determining whether the log requirement is completed by the completion time for the log requirement comprises determining whether the log item has be completed by a site user associated with log requirement.

11. The system of claim 8, the operations further comprising:
receiving, from a user device, a request for a user interface that displays log items for a site;
accessing the data store to determine the instantiated log items for the site; and
generating and providing to the user interface display data that causes the user device to display, in the user interface, the instantiated log items for the site.

12. The system of claim 8, the operations further comprising:
receiving, from a user device, a request for a user interface that displays log items for a site according to a plurality of successive time windows, wherein the successive time windows include time windows that occur prior to a current time window, a current time window, and future time windows that occur after the current time window;
accessing the data store to determine the instantiated log items for the site; and
generating and providing to the user interface display data that causes the user device to display, in the user interface, the instantiated log items for the site.

13. The system of claim 12 wherein accessing the data store to determine the instantiated log items for the site comprises:
determining all instantiated log items for the site for the current time window and prior time windows; and
generating and providing to the user interface display data that causes the user device to display, in the user interface, the instantiated log items for the site for each of the current time window and the prior time windows.

14. The system of claim 8, wherein the instantiation time window is a daily window of 24 hours, and periodically executing the instantiation service that instantiates log items comprises executing the instantiation service daily.

15. A non-transitory computer readable medium storing instructions executable by one or more computers and that upon execution cause the one or more computers to perform operations comprising:
storing, in a data store, a first association of a plurality of sites and a plurality of log requirements, wherein the first association associates, for each site, a set of log requirements for the site, wherein:
each log requirement specifies an instantiation time that is a time a log item is instantiated; and
each site specifies a particular physical location that is different from each other physical location for each other site;
periodically executing an instantiation service that instantiates log items, wherein for each execution the instantiation service:
determines an instantiation time window measured from a start time and to an end time that occurs after the start time;
processes the first association of the plurality of sites and the plurality of log requirements, and for each log requirement of the plurality of log requirements, determines whether the instantiation time for the log requirement specifies a time that occurs within the instantiation time window;
for each log requirement determined to have an instantiation time that falls within the instantiation time window, instantiating the log item of the log requirement and storing the instantiated log items in a data store; and
for each log requirement determined not to have an instantiation time that falls within the instantiation time window, not instantiating the log item of the log requirement.

16. The non-transitory computer readable medium of claim 15, wherein:
each log requirement specifies a completion time for the log requirement; and
the operations further comprising:
for each log requirement for which a log item has been instantiated, determining, by the data processing apparatus, whether the log requirement is completed by the completion time for the log requirement;
for each log requirement for which the log item has been instantiated and determined not to be completed by the completion time for the log requirement, generating a first notification specifying the log requirement was not completed by the completion time and sending the first notification to a notified user associated with the log requirement; and
for each log requirement for which the log item has been instantiated and determined to be completed by the completion time for the log requirement, generating a second notification specifying the log requirement was completed and sending the sending the second notification to a notified user associated with the log requirement.
